(19) United States
(12) Patent Application Publication
(10) Pub. No.: US 2022/0184991 A1
(43) Pub. Date: Jun. 16, 2022

(54) POROUS POLYMER SUBSTRATES AND COATINGS FOR BANKNOTES AND OTHER SECURITY ARTICLES

(71) Applicant: Spectra Systems Corporation, Providence, RI (US)

(72) Inventor: Nabil Lawandy, Saunderstown, RI (US)

(21) Appl. No.: 17/553,422

(22) Filed: Dec. 16, 2021

Related U.S. Application Data
(60) Provisional application No. 63/126,488, filed on Dec. 16, 2020.

(51) Int. Cl. B42D 25/36; B42D 25/29; B42D 25/351

(52) U.S. Cl. CPC B42D 25/36; B42D 25/351; B42D 25/29

(57) ABSTRACT

A secure instrument including at least one porous polymer substrate including at least one porous polymer, or a substrate and at least one porous polymer layer or coating including at least one porous polymer, said at least one porous polymer layer or coating disposed on the substrate, where the at least one porous polymer substrate, layer, or coating has pores or channels sized to permit water to enter the pores or channels, and sized to prevent one or more viruses or bacteria from entering the pores or channels.

### CROSS-REFERENCE TO RELATED APPLICATIONS

The present application claims priority to U.S. provisional application Ser. No. 63/126,488, filed Dec. 16, 2020, the disclosure of which is incorporated herein by reference in its entirety.

### TECHNICAL FIELD

The present invention relates to porous polymer substrates and coatings. More particularly, the present invention relates to porous polymer substrates and coatings for use in polymer banknotes.

### BACKGROUND OF THE INVENTION

Polymer substrates have provided more durable substrates for banknotes than paper. These substrates are primarily made of biaxially-oriented polypropylene (BOPP). The biaxial orientation provides mechanical strength. Suppliers boast that polymer banknotes last longer and are more difficult to counterfeit than paper money. Polymer banknotes have been in use in Australia for decades, and many other countries, including New Zealand, Canada, and Romania, rely on polymers for recyclable and easily verifiable currency.

The Bank of Canada makes its banknotes from polyethylene terephthalate (PET). PET is a strong, lightweight, transparent plastic commonly used to make drink bottles, cosmetic packaging, and food-grade packaging, as well as serving as a basic material for blood vessel implants.

One process of fabricating polymer materials into currency starts with small polymer pellets that are melted and then stretched into a multi-story tall thin plastic “bubble.” At the bottom of the bubble, the polymer is cooled and gathered into rolls, where an infrared gauge checks that the polymer film has the correct thickness. The polymer sheets are wrapped into rolls, and then printed with the banknote design as well as any security features that help to prevent counterfeiting.

One of the problems with polymer banknotes is the lack of porosity, as compared to paper banknotes. As such, the liquid of droplets disposed on the surface of the polymer banknotes are not taken in or absorbed by the banknotes, thereby sitting on the surface for long periods of time. Such droplets may contain bacteria and viruses, such as COVID-19/SARS-CoV-2 and Ebola, which survive for longer periods of time due to the hydration and mechanical protection from fluid flow provided by the stationary droplet. Both COVID-19/SARS-CoV-2 and Ebola have been shown to survive for several days on polymer banknotes and other non-porous surfaces, which is the likely result of promoting and sustaining a water-based environment around the virus and its spike protein, for example. Paper banknotes have exhibited shorter viral deactivation times, which is believed to be due to the ability of the porous paper substrate to drain water away from the droplet, leaving the virus to ultimately change its structure and become deactivated. Therefore, there is a need for a substrate or coating having a porosity sufficient to achieve enhanced bacterial and viral deactivation.

### SUMMARY OF THE INVENTION

In general, in one aspect, the invention features a secure instrument including at least one porous polymer substrate including at least one porous polymer, where the at least one porous polymer substrate has pores or channels sized to permit water to enter the pores or channels, and sized to prevent one or more viruses or bacteria from entering the pores or channels.

Implementations of the invention may include one or more of the following features. The at least one porous polymer may include one or more of polytetrafluoroethylene (PTFE), polyethylene terephthalate (PET), and biaxially-oriented polypropylene (BOPP). The at least one porous polymer substrate may include a biaxially-oriented polypropylene (BOPP) layer having a thickness of 60 to 100 microns. The pores or channels may have an effective hydrodynamic pore size of less than 200 nm, including 100 nm. The index of refraction of the at least one porous polymer may be approximately the same or the same as an index of refraction of water. The secure instrument may further include a transparent window formed by removal of a portion of an opacity layer or inclusion of an index-matching polymer. The secure instrument may be a banknote.

In general, in another aspect, the invention features a secure instrument including a substrate and at least one porous polymer layer or coating including at least one porous polymer, said at least one porous polymer layer or coating disposed on the substrate, where the at least one porous polymer layer or coating has pores or channels sized to permit water to enter the pores or channels, and sized to prevent one or more viruses or bacteria from entering the pores or channels.

Implementations of the invention may include one or more of the following features. The at least one porous polymer may include one or more of polytetrafluoroethylene (PTFE), polyethylene terephthalate (PET), and biaxially-oriented polypropylene (BOPP). The substrate may be a biaxially-oriented polypropylene (BOPP) layer having a thickness of 60 to 100 microns. The pores or channels may have an effective hydrodynamic pore size of less than 200 nm, including 100 nm. The index of refraction of the at least one porous polymer may be approximately the same or the same as an index of refraction of water.

Information in the form of shape(s), text lettering, or image(s) may be printed on a side of the substrate that is disposed in contact with the at least one porous polymer layer or coating. The index of refraction of the at least one porous polymer layer or coating may be approximately the same or the same as the index of refraction of the substrate such that the information printed on the substrate is visible through the at least one porous polymer layer or coating.

The at least one porous polymer layer or coating may consist of two porous polymer layers or coatings disposed on opposing sides of the substrate. Information in the form of shape(s), text lettering, or image(s) may be printed on each side of the substrate that is disposed in contact with the two porous polymer layers or coatings, respectively, and the information printed on each side of the substrate may be the same information or different information. The index of refraction of each of the two porous polymer layers or coatings may be approximately the same or the same as the index of refraction of the substrate such that the information printed on the substrate is visible through each of the two porous polymer layers or coatings. The secure instrument may be a banknote.

### BRIEF DESCRIPTION OF THE DRAWINGS

FIG. 1A is a diagram of a multi-layered composite structure according to one embodiment of the present invention;

FIG. 1B is a diagram of a multi-layered composite structure according to another embodiment of the present invention;

FIG. 2 is a comparison of illustrations showing the activity of virus-containing droplets on typical non-porous polymer substrates and porous polymer substrates of the present invention at various points in time;

FIG. 3 shows several images of a porous polymer substrate of the present invention and its response to a phosphor-containing droplet disposed thereon;

FIG. 4 shows several images of a porous polymer substrate of the present invention and its response to a phosphor-containing droplet disposed thereon;

FIG. 5 shows an image of a non-porous polymer substrate and its response to a phosphor-containing droplet disposed thereon;

FIG. 6 shows a comparison among different banknotes, namely Canadian dollars, Indian rupees, and U.S. dollars, concerning the survival time of the SARS-CoV-2 virus thereon;

FIG. 7 shows a comparison among different banknotes, namely Canadian dollars, Indian rupees, and U.S. dollars, concerning the survival time of the Ebola virus thereon;

FIG. 8 shows a comparison among different polytetrafluoro-ethylene (PTFE) hydrophilic membranes having different pore sizes concerning the survival time of the SARS-CoV-2 virus thereon;

FIG. 9A shows a banknote formed of a porous polymer substrate having 100 nm pores prior to the creation of an index-matched window; and

FIG. 9B shows a banknote formed of a porous polymer substrate having 100 nm pores after the creation of an index-matched window.

### DETAILED DESCRIPTION OF THE INVENTION

The present invention is directed to porous polymer substrates and coatings, such as for use in polymer banknotes or as coatings on paper banknotes. The substrates and coatings of the present invention may serve a bio-protective function, particularly for rapid viral and bacterial deactivation in durable polymer banknotes. The substrates and coatings of the present invention utilize polymers having sufficiently sized pores in such substrates and coatings, such polymers including but not limited to polytetrafluoroethylene (PTFE), polyethylene terephthalate (PET), biaxially-oriented polypropylene (BOPP), and the like. In one non-limiting embodiment of the present invention, banknotes include a 60 to 100 micron layer of porous BOPP or similarly acceptable polymer as the substrate. The polymers are selected as having high porosity with channels sized to permit water to permeate the surface, but not the relevant virus or bacterium. In doing so, water from a droplet containing the virus or bacterium is taken in or absorbed by the substrate or coating, which leaves the virus or bacterium in a water-free environment on the surface, resulting in viral or bacterial deactivation. By way of example, an effective hydrodynamic pore size of less than 200 nm is required to deactivate the SARS-CoV-2 virus.

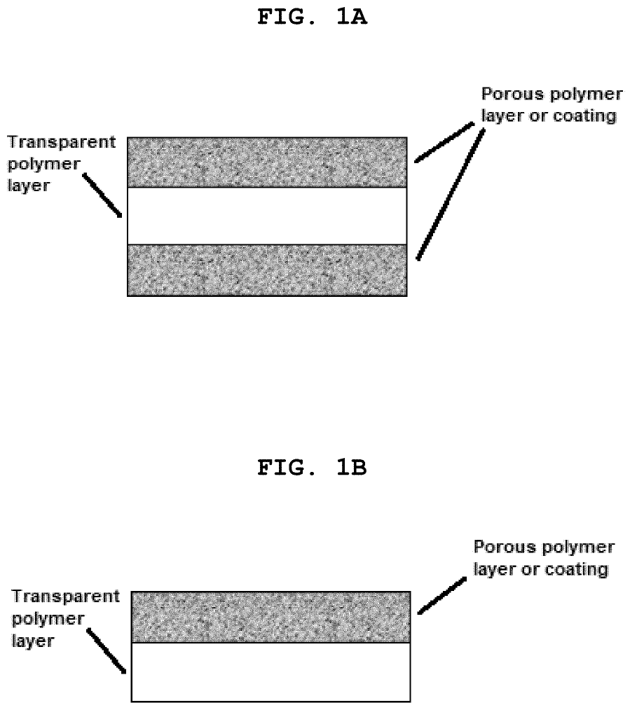

In another embodiment of the present invention, a multi-layered composite structure including a transparent polymer layer (e.g., BOPP) is provided, namely one in which the layer acts as a support or substrate for an additional layer or layers. In one example, shown in FIG. 1A, the multi-layered structure is a three-layer structure in which the transparent polymer layer (e.g., BOPP) serves as a middle support layer, and porous polymer substrates or coatings are provided on opposite sides of the transparent polymer layer, the porous polymer substrates or coatings being composed of either the same or a different polymer. In another example, shown in FIG. 1B, the multi-layered structure is a two-layer structure in which the transparent polymer layer (e.g., BOPP) serves as a support layer, and a porous polymer substrate or coating is provided on one side of the transparent polymer layer. In these embodiments, material may be printed on top or below the transparent polymer layer, such printed material including shapes, text lettering, or images. Different printed material may be provided on opposite sides of the transparent polymer layer. Finally, index-matching aspects described infra may be employed in connection with this multi-layered structure embodiment such that the printed material on the transparent polymer layer is visible through the porous polymer substrate/coating.

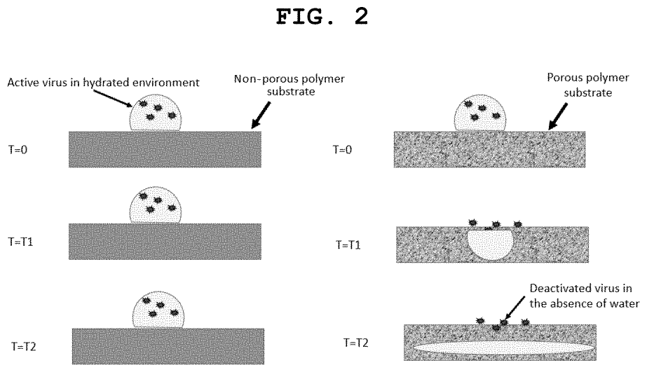

FIG. 2 illustrates activity over time of a virus-containing droplet (i.e., active virus in hydrated environment) on a non-porous polymer substrate and a porous polymer substrate. For the non-porous polymer substrate, the droplet sits on the surface of the substrate for an extended period, unable to be taken in or absorbed by the non-porous polymer substrate. Accordingly, the virus remains active on the surface for a long period of time due to the maintained hydrated environment. For the porous polymer substrate, water from the virus-containing droplet is taken in or absorbed by the porous polymer substrate, which may occur over the course of a few seconds, leaving the virus behind on the surface. Consequently, the virus is deactivated as a result of the loss of the hydrated environment. In particular, deactivation is due to both dehydration as well as fluid flow forces associated with the draining into the substrate, which can affect the relatively delicate viral encapsulation and surface proteins.

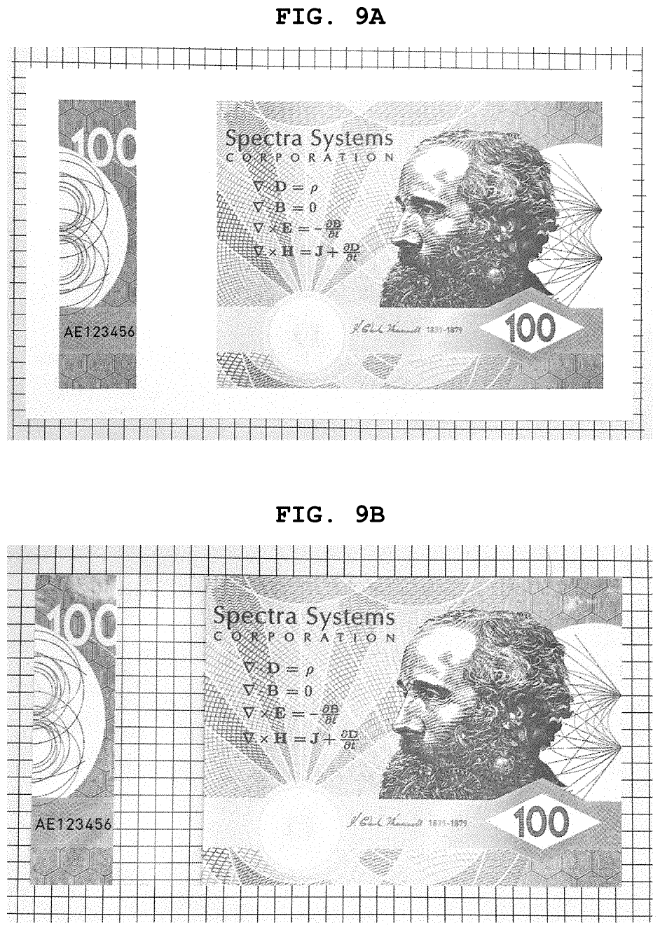

As noted above, polymer banknotes have been known to utilize BOPP as the relevant polymer. Often, these banknotes include a highly transparent window as a security feature, where an opacity layer and printing are absent from this transparent window. Banknotes including the porous polymer substrates or coatings of the present invention may also include such a transparent window, including by omitting the opacity layer and printing while also impregnating the selected polymer locally with a material that sufficiently matches the refractive index of the selected polymer or by utilizing a non-porous polymer for the window, which can also be patterned. The window can be created by locally impregnating the banknote substrate with a photocurable index-matching polymer, which is locally cured with the uncured portions of the banknote being washed away with a solvent to remove the uncured portions, returning them to a scattering state and white color. FIG. 9 provides an example in which a banknote formed of a porous polymer substrate having 100 nm pores is impregnated with a photocurable (UV) index-matching polymer, locally cured, and rinsed with solvent to removed uncured portions. FIG. 9A depicts the banknote prior to creation of an index-matched window. FIG. 9B depicts the banknote after the index-matched window is created and the border around the banknote has been removed. A clear window of any shape or design may be produced that can also support foils and other common banknote security features. The photocured or evaporatively-cured index-matching polymer can also be deposited to produce a lens or a collection/array of lenses as an additional security feature. The same photocurable index-matching polymer can also be impregnated with taggants that emit or absorb radiation at specific wavelengths, e.g., in the infrared (IR) or near IR regions, for machine-readable capabilities. Additionally, banknotes including the porous polymer substrates or coatings of the present invention may not require an opacity layer, which is highly scattering and appears white. With banknotes including the porous polymer substrates or coatings of the present invention, an antistatic layer may not be required, as such banknotes, due to their porosity, have much less material in contact with other banknotes when stacked.

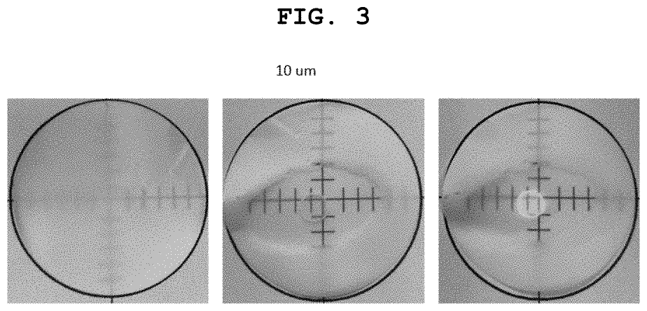

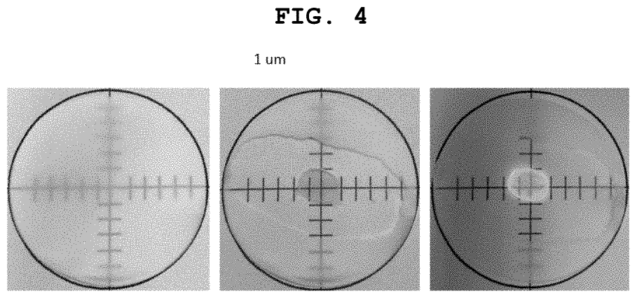

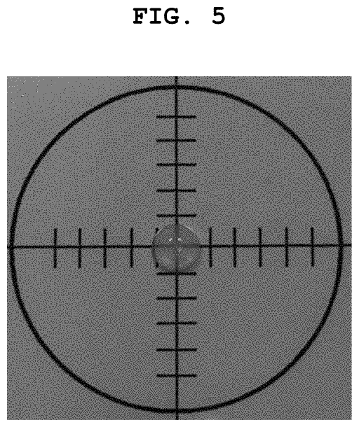

FIGS. 3-4 provide respective sets of images illustrating porous polymer substrates of the present invention upon disposition of a phosphor-containing droplet thereon. Phosphors are selected to mimic the activity of viruses in a hydrated environment. The porous polymer substrate of FIG. 3 has a pore size of 10 microns, while the porous polymer substrate of FIG. 4 has a pore size of 1 micron. Both sets of images demonstrate similar activity of the porous polymer substrates. Prior to the disposition of the phosphor-containing droplet on the porous polymer substrate, the substrate is substantially opaque; this is the result of light passing through the porous polymer substrate refracting and scattering at each boundary between air in the pores and the polymer material (which has a higher index of refraction, e.g., 1.35, than that of air). When the droplet is placed on the substrate and water is taken in or absorbed by the pores, those portions of the substrate in which the pores are filled with water may have an index of refraction close to or matching that of the polymer material(e.g., the index of refraction of water is 1.33), and thus have a higher clarity or transparency due to less refracting and scattering of light passing through the substrate and at the boundaries between water-filled pores and the polymer. The phosphor is left on the surface of the substrate and is not taken in or absorbed by the pores of the porous polymer substrate. The substrate returns to its initial opacity as water is drawn away from the pores of the porous polymer substrate, e.g., by evaporation or sublimation, with the phosphor remaining on the surface of the substrate. Compare FIGS. 3-4 with FIG. 5, in which a phosphor-containing polymer nanosphere (D=100 nm) droplet is disposed on a non-porous polymer substrate. Note that SARS-CoV-2 is 80 nm in diameter. In this example, the droplet remains on the surface of the substrate and its water is not taken in or absorbed by the substrate, resulting in the droplet remaining hydrated.

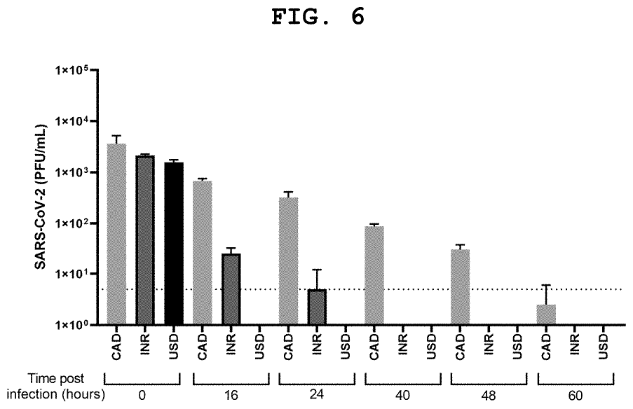

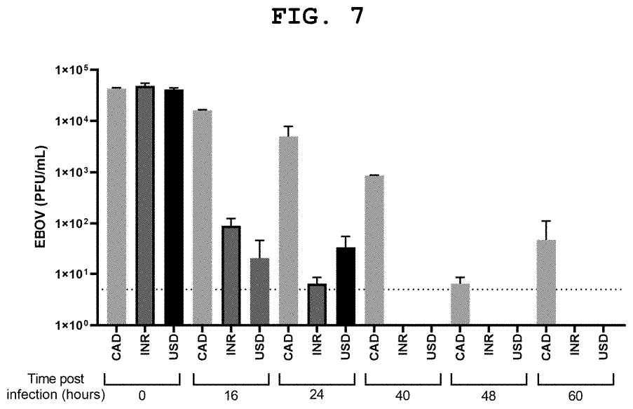

FIGS. 6-7 present evidence of the survival time of the SARS-CoV-2 and Ebola viruses on various banknotes, namely Canadian dollars, Indian rupees, and U.S. dollars. While Indian rupees and U.S. dollars are paper-based currency, Canadian dollars are non-porous polymer-based currency. 100 microliters of the relevant virus (SARS-CoV-2 p6 or EBOV p4) were added to the banknotes in duplicate. A plaque assay was utilized to determine virus titer. The measurement time points (+/−10 minutes) were 0 hours, 16 hours, 24 hours, 40 hours, 48 hours, and 60 hours. As shown with respect to both the SARS-CoV-2 and Ebola viruses, such viruses survived far longer on Canadian dollars than on both Indian rupees and U.S. dollars.

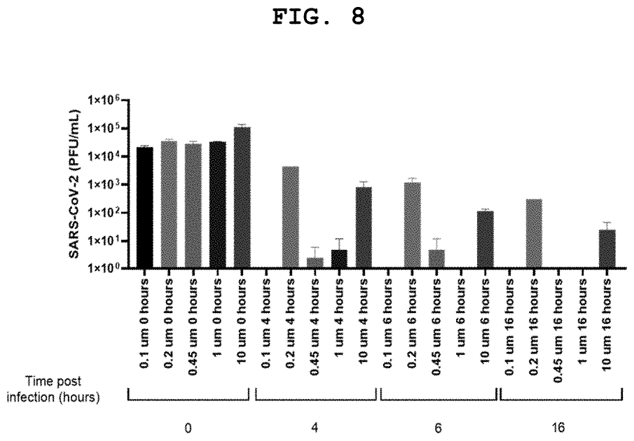

FIG. 8 presents evidence of the survival time of the SARS-CoV-2 virus on hydrophilic PTFE membranes of varying pore size. 100 microliters of solution containing the SARS-CoV-2 virus were added to the membranes in duplicate. A plaque assay was utilized to determine virus titer. The data shows that pore size of the porous polymer membrane can dramatically affect life of the SARS-CoV-2 virus. Utilization of the 100 nm pore size membrane resulted in full inactivation or complete trapping of the virus to prevent elution into solutions used to test for presence of the active virus. The 200 nm pore size membrane also provided remarkable protection against the virus, while membranes having intermediate pores sizes, such as 450 nm and 1,000 nm (1 micron), had inactivation effects comparable to membranes with the largest pore size of 10 microns. This behavior may be due to competing effects of lower relative humidity in small pores and protective mechanisms as well. In addition, hydrodynamic forces of wicking into the membranes may cause the destruction or inactivation of spike proteins in the SARS-CoV-2 virus surface.

The embodiments and examples above are illustrative, and many variations can be introduced to them without departing from the spirit of the disclosure or from the scope of the appended claims. For example, elements and/or features of different illustrative and exemplary embodiments herein may be combined with each other and/or substituted with each other within the scope of this disclosure. The objects of the invention, along with various features of novelty which characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

What is claimed is:

1. A secure instrument comprising:
at least one porous polymer substrate comprising at least one porous polymer,
wherein the at least one porous polymer substrate has pores or channels sized to permit water to enter the pores or channels, and sized to prevent one or more viruses or bacteria from entering the pores or channels.

2. The secure instrument of claim 1, wherein the at least one porous polymer comprises one or more of polytetrafluoroethylene (PTFE), polyethylene terephthalate (PET), and biaxially-oriented polypropylene (BOPP).

3. The secure instrument of claim 1, wherein the at least one porous polymer substrate comprises a biaxially-oriented polypropylene (BOPP) layer having a thickness of 60 to 100 microns.

4. The secure instrument of claim 1, wherein the pores or channels have an effective hydrodynamic pore size of less than 200 nm.

5. The secure instrument of claim 4, wherein the pores or channels have an effective hydrodynamic pore size of 100 nm.

6. The secure instrument of claim 1, wherein the index of refraction of the at least one porous polymer is approximately the same or the same as the index of refraction of water.

7. The secure instrument of claim 1, further comprising a transparent window formed by removal of a portion of an opacity layer or inclusion of an index-matching polymer.

8. The secure instrument of claim 1, wherein the secure instrument is a banknote.

9. A secure instrument comprising:
a substrate; and
at least one porous polymer layer or coating comprising at least one porous polymer, said at least one porous polymer layer or coating disposed on the substrate,
wherein the at least one porous polymer layer or coating has pores or channels sized to permit water to enter the pores or channels, and sized to prevent one or more viruses or bacteria from entering the pores or channels.

10. The secure instrument of claim 9, wherein the at least one porous polymer comprises one or more of polytetrafluoroethylene (PTFE), polyethylene terephthalate (PET), and biaxially-oriented polypropylene (BOPP).

11. The secure instrument of claim 9, wherein the substrate is a biaxially-oriented polypropylene (BOPP) layer having a thickness of 60 to 100 microns.

12. The secure instrument of claim 9, wherein the pores or channels have an effective hydrodynamic pore size of less than 200 nm.

13. The secure instrument of claim 12, wherein the pores or channels have an effective hydrodynamic pore size of 100 nm.

14. The secure instrument of claim 9, wherein the index of refraction of the at least one porous polymer is approximately the same or the same as the index of refraction of water.

15. The secure instrument of claim 9, wherein information in the form of shape(s), text lettering, or image(s) is printed on a side of the substrate that is disposed in contact with the at least one porous polymer layer or coating.

16. The secure instrument of claim 15, wherein the index of refraction of the at least one porous polymer layer or coating is approximately the same or the same as the index of refraction of the substrate such that the information printed on the substrate is visible through the at least one porous polymer layer or coating.

17. The secure instrument of claim 9, wherein the at least one porous polymer layer or coating consists of two porous polymer layers or coatings disposed on opposing sides of the substrate.

18. The secure instrument of claim 17,
wherein information in the form of shape(s), text lettering, or image(s) is printed on each side of the substrate that is disposed in contact with the two porous polymer layers or coatings, respectively, and
wherein the information printed on each side of the substrate is the same information or different information.

19. The secure instrument of claim 18, wherein the index of refraction of each of the two porous polymer layers or coatings is approximately the same or the same as the index of refraction of the substrate such that the information printed on the substrate is visible through each of the two porous polymer layers or coatings.

20. The secure instrument of claim 9, wherein the secure instrument is a banknote.
